(19) United States
(12) Patent Application Publication
(10) Pub. No.: US 2009/0020685 A1
(43) Pub. Date: Jan. 22, 2009

(54) LIGHT EMITTING DEVICE AND ITS CALIBRATING AND CONTROL METHODS

(75) Inventor: Chung-Jyh LIN, YongKang City (TW)

Correspondence Address: BIRCH STEWART KOLASCH & BIRCH, PO BOX 747, FALLS CHURCH, VA, 22040-0747, US

(73) Assignee: AUSSMAK OPTOELECTRONIC CORP., Yongkang City (TW)

(21) Appl. No.: 12/167,894

(22) Filed: Jul. 3, 2008

(30) Foreign Application Priority Data
Jul. 19, 2007 (TW) 096126447

(51) Int. Cl. G01J 1/32

(52) U.S. Cl. 250/205

(57) ABSTRACT

A calibrating method of a light emitting device, which includes at least one light-emitting diode (LED) unit. The calibrating method includes the steps of inputting a brightness control signal to the LED unit, measuring a lighting brightness of the LED unit, and writing an initial relation of the brightness control signal and the lighting brightness into a memory unit. In addition, a light emitting device and a controlling method thereof are also disclosed.

### CROSS REFERENCE TO RELATED APPLICATIONS

This Non-provisional application claims priority under 35 U.S.C. §119(a) on Patent Application No(s). 096126447 filed in Taiwan, Republic of China on Jul. 19, 2007, the entire contents of which are hereby incorporated by reference.

### BACKGROUND OF THE INVENTION

1. Field of Invention

The invention relates to a light emitting device and the calibrating method and control method thereof.

2. Related Art

Compared with the general light source, such as light bulb or tube, the light-emitting diode (LED) has the advantages of longer lifetime, lower power consumption and smaller size. In addition, the technology of LED is well developed, so that the LED has been applied to the indicator, backlight module and illumination device,

In general, the manufacture variation makes the LEDs, which are manufactured at the same time, have different brightness under the same driving signal. In order to present true or better color, it is very important technique to control the average brightness of the LEDs, in particular, for the backlight module, which includes many LEDs.

As shown in FIG. 1A, a conventional backlight module includes a plurality of LEDs 11, a photo sensor 12 and a controller 13. The photo sensor 12 receives the light generated by each of the LEDs 11, and then generates a feedback signal to the controller 13. Then, the controller 13 adjusts the brightness of the corresponding LED 11 according to the feedback signal.

Recently, another conventional backlight module is disclosed. In this case, the conventional backlight module includes a plurality of LEDs 11, which are divided into several areas. As shown in FIG. 1B, the LEDs 11 are divided into 12 areas. Each area has for LEDs 11 and a photo sensor 12, so that the brightness of each area can be individually adjusted. However, since the LEDs 11 are divided into 12 areas, the controller (not shown) for adjusting the brightness of the LEDs 11 must have 12 channels for controlling the brightness of the LEDs 11 in the 12 areas, respectively.

As mentioned above, the manufacturing variation of the LED, the packaging of the LED and the distance between the photo sensor and the LED may cause the different coupling coefficients of the LED and the photo sensor, so that the sensing efficiencies are different. This will lead to the inconvenience in detecting the lighting brightness of the LED and the difficulty to adjust the slight differences between the LEDs.

Therefore, it is an important subject to properly control the brightness of the LEDs in the light emitting device.

### SUMMARY OF THE INVENTION

In view of the foregoing, the invention is to provide a light emitting device and the calibrating and control methods thereof that can eliminate the optical coupling difference between each LED and the optical feedback sensor.

To achieve the above, the invention discloses a light emitting device including at least one light-emitting diode (LED) unit, a memory unit and a control unit. The LED unit controls a lighting brightness thereof according to a brightness control signal. The memory unit stores an initial relation of the brightness control signal and the lighting brightness of the LED unit. The control unit is electrically connected to the LED unit and the memory unit. The control unit determines the lighting brightness of the LED unit according to a brightness required signal and the initial relation.

To achieve the above, the invention also discloses a calibrating method of a light emitting device. The light emitting device includes at least one LED unit. The calibrating method includes the steps of inputting a brightness control signal to the LED unit, measuring a lighting brightness of the LED unit, and writing an initial relation of the brightness control signal and the lighting brightness into a memory unit.

In addition, the invention further discloses a control method of a light emitting device. The light emitting device includes at least one LED unit and a memory unit, and the memory unit at least stores an initial relation of a brightness control signal and a lighting brightness for diving the LED unit. The control method includes the steps of reading the initial relation from the memory unit, and determining the brightness control signal for the LED unit according to a brightness requirement and the initial relation.

As mentioned above, in the light emitting device and the calibrating and control methods thereof, the initial relation between the brightness control signal and the lighting brightness of the light emitting device is stored in the memory unit in advance. Thus, when the light emitting device is installed in a system, the light emitting device can obtain the corresponding brightness control signal by the calculation or table lookup method according to the initial relation after receiving the required lighting brightness. Then, the LED unit of the light emitting device can be driven according to the brightness control signal. Accordingly, when there are multiple LED units, the lighting brightness of the LED units can be adjusted to be the same according to the corresponding initial relations.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic illustration of the conventional architecture for adjusting the brightness of LEDs;

FIG. 1B is a schematic illustration showing a part of a conventional light emitting device;

FIG. 2 is a schematic illustration of the architecture of a light emitting device according to an embodiment of the invention;

FIG. 3 is a schematic illustration of the architecture of another light emitting device according to the embodiment of the invention, wherein the first switch element and the LED are connected in parallel;

FIG. 4 is a schematic illustration of the architecture of still another light emitting device according to the embodiment of the invention, which further includes a rectifier;

FIG. 5 is a flow chart showing a calibrating method of the light emitting device according to the embodiment of the invention;

FIG. 6 is a flow chart showing a control method of the light emitting device according to the embodiment of the invention; and

FIG. 7 is a flow chart of the step S13 of FIG. 6.

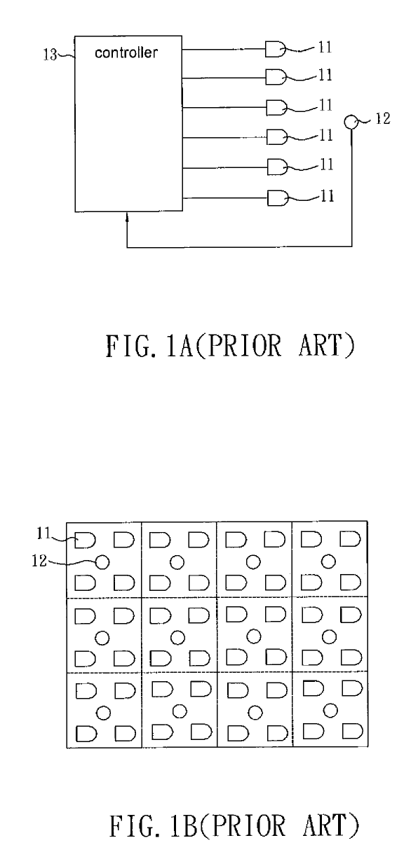

### DETAILED DESCRIPTION OF THE INVENTION

The present invention will be apparent from the following detailed description, which proceeds with reference to the accompanying drawings, wherein the same references relate to the same elements.

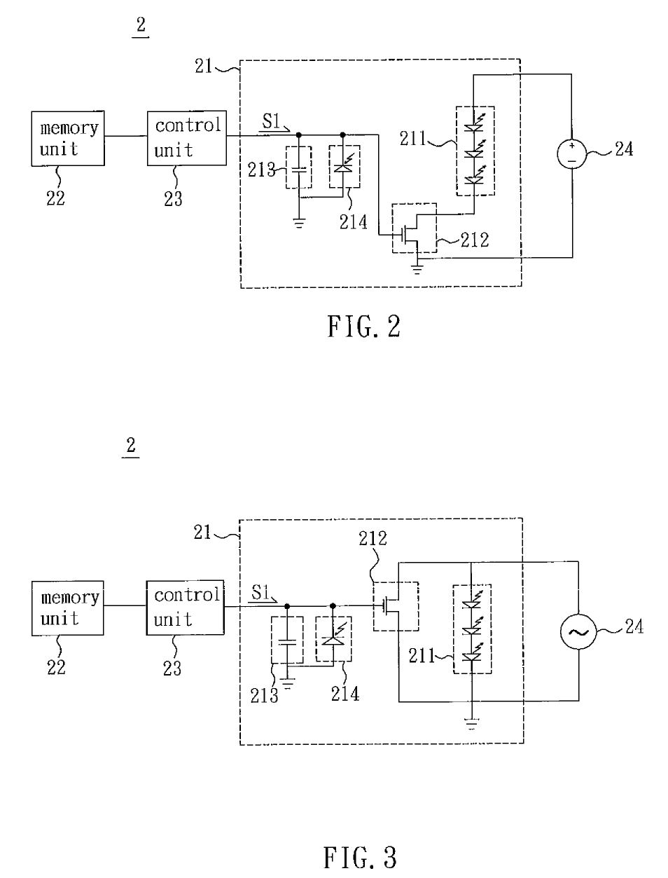

With reference to FIG. 2, a light emitting device 2 according to an embodiment of the invention includes at least one LED unit 21, a memory unit 22 and a control unit 23. In the embodiment, the light emitting device 2 can be a light bar or be applied to a backlight module or illumination.

The LED unit 21 controls the lighting brightness thereof according to a brightness control signal S1. In the embodiment, the LED unit 21 includes at least one LED 211, at least one first switch element 212, at least one energy-storage element 213 and at least one photo sense-control element 214.

The first switch element 212 is electrically connected to the LED 211, and the first switch element 212 can be a BJT (Bipolar Junction Transistor) or an FET (Field Effect Transistor). In the embodiment, the first switch element 212 is, for example, a MOSFET (Metal-Oxide-Semiconductor Field-Effect Transistor). As shown in FIG. 2, the first switch element 212 and the LED 211 can be connected in series. As shown in FIG. 3, the first switch element 212 and the LED 211 can be connected in parallel.

Referring to FIG. 2, the energy-storage element 213 is electrically connected to the first switch element 212 and stores the brightness control signal S1. In the embodiment, the energy-storage element 213 can be a capacitor, and the brightness control signal S1 is a voltage form, which is stored in the capacitor. Of course, depending on different properties of the energy-storage element 213, the brightness control signal S1 can be different forms, such as a current form, stored in the energy-storage element 213.

The photo sense-control element 214, which is electrically connected to the energy-storage element 213, senses the illumination energy of the LED 211 and then adjusts the brightness control signal S1 according to the illumination energy. Then, the first switch element 212 is tuned on/off according to the value of the brightness control signal S1 stored in the energy-storage element 213, thereby enabling or disabling the LED 211. In this case, the first switch element 212 is tuned on/off according to the obvious changes of the value of the brightness control signal S1. In the embodiment, the photo sense-control element 214 includes a photo diode and is connected with the energy-storage element 213 in parallel. In addition, the photo sense-control element 214 may include a control circuit (not shown), which is connected to the photo diode for achieving additional control.

To be noted, the above-mentioned “electrically connect” can be directly or indirectly electrically connect. The indirectly electrically connect means that two elements are electrically connected through an additional element.

The memory unit 22 stores an initial relation of the brightness control signal S1 and the lighting brightness of the LED unit 21. The initial relation is a measured relation between the brightness control signal S1 and the lighting brightness of each LED unit after the light emitting device 2 is manufactured. The initial relation can be concluded and be represented by a mathematic function or by a comparison table so as to show that different lighting brightness corresponds to different brightness control signal S1. In the embodiment, the memory unit 22 is a non-volatile memory.

The control unit 23 is electrically connected to the LED unit 21 and the memory unit 22. In the embodiment, the control unit 23 determines a value of the brightness control signal S1 according to a brightness required signal and the initial relation.

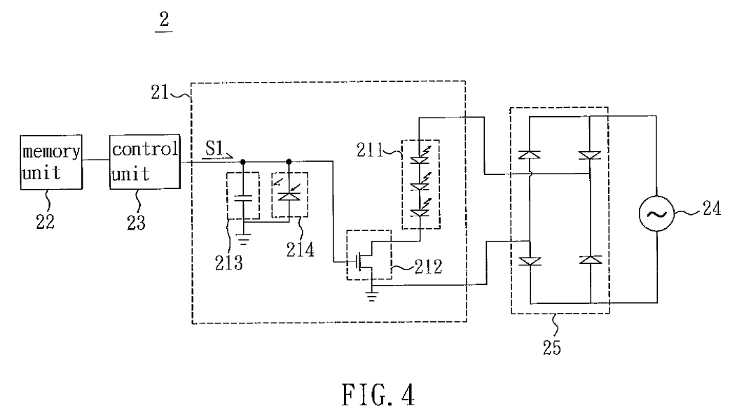

In addition, the light emitting device 2 can further include a power supplier 24 for providing a DC power or an AC power to the LED 211. As shown in FIG. 4, if the power supplier 24 provides an AC power, the light emitting device 2 further includes a rectifier 25, which can be a full-bridge rectifier, for transforming the AC power into a DC power, which is then provided to the LED 211.

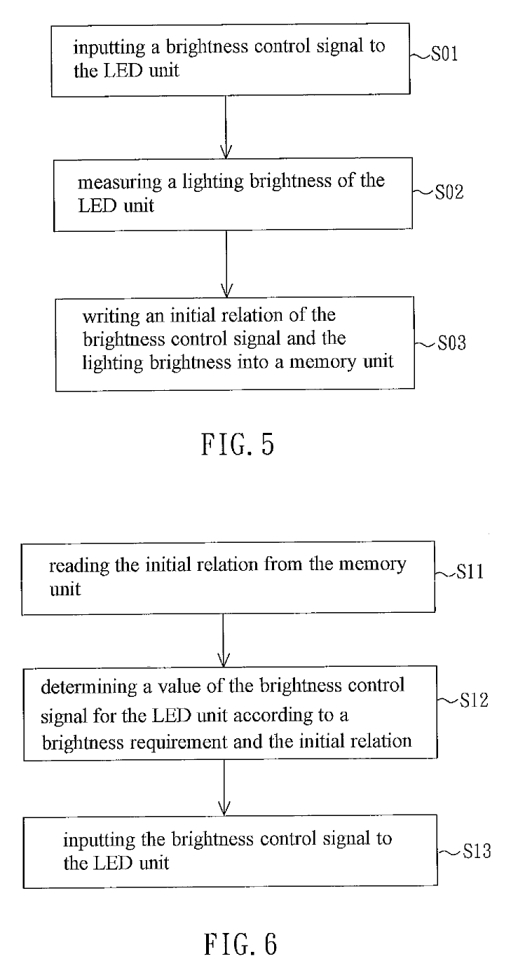

As mentioned above, when the light emitting device 2 includes a plurality of LED units 21, the LED units 21 can be individually controlled. However, since the coupling coefficients of the LED units 21 are different, the errors may be generated during controlling. The calibrating method of the light emitting device according to the embodiment of the invention will be described herein below with reference to FIG. 5.

Referring to FIG. 5, the calibrating method of the light emitting device, such as the above-mentioned light emitting device 2, includes the following steps S01 to S03.

Step S01 is to input a brightness control signal to the LED unit 21. Thus, the LEDs of the LED unit 21 can emit light according to the brightness control signal.

Steps S02 is to measure a lighting brightness of the LED unit. In the embodiment, the lighting brightness is an average brightness of the LEDs.

Step S03 is to write an initial relation of the brightness control signal and the lighting brightness into a memory unit. Herein, the initial relation can be concluded and represented by a mathematic function or a comparison table.

In addition, after the calibration, a control method of the light emitting device, which includes the steps S11 to S13, can be performed as shown in FIG. 6.

Step S11 is to read the initial relation from the memory unit. Step S12 is to determine a value of the brightness control signal for the LED unit according to a brightness requirement and the initial relation. Step S13 is to input the brightness control signal to the LED unit.

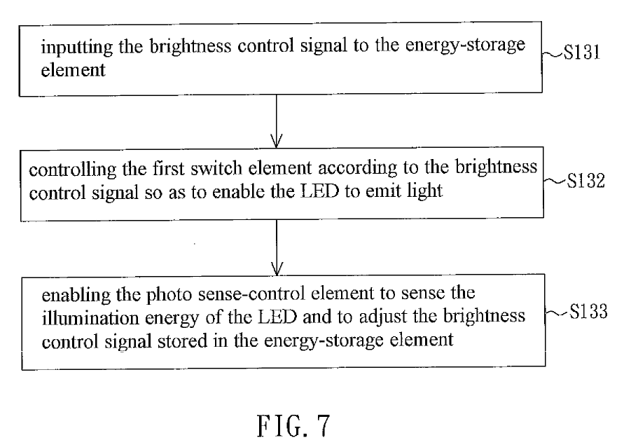

The light emitting device can be the above-mentioned light emitting device 2. In addition, with reference to FIGS. 7 and 2, the step S13 further includes the steps S131 to S133.

Step S131 is to input the brightness control signal to the energy-storage element. Step S132 is to control the first switch element according to the brightness control signal so as to enable the LED to emit light. Step S133 is to enable the photo sense-control element to sense the illumination energy of the LED and to adjust the brightness control signal stored in the energy-storage element. In brief, the lighting brightness of the LEDs is controlled by the brightness control signal with different values, and the valued of the brightness control signal can be determined according to the initial relation and the required light brightness of the light emitting device. In addition, the light emitting device can control the first switch element according to the brightness control signal so as to disable the LEDs.

In summary, in the light emitting device and the calibrating and control methods thereof the initial relation between the brightness control signal and the lighting brightness of the light emitting device is stored in the memory unit in advance. Thus, when the light emitting device is installed in a system, the light emitting device can obtain the corresponding brightness control signal by the calculation or table lookup method according to the initial relation after receiving the required lighting brightness. Then, the LED unit of the light emitting device can be driven according to the brightness control signal. Accordingly, when there are multiple LED units, the lighting brightness of the LED units can be adjusted to be the same according to the corresponding initial relations.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A calibrating method of a light emitting device, wherein the light emitting device comprises at least one light-emitting diode (LED) unit, the calibrating method comprising steps of:
inputting a brightness control signal to the LED unit;
measuring a lighting brightness of the LED unit; and
writing an initial relation of the brightness control signal and the lighting brightness into a memory unit.

2. The calibrating method according to claim 1, wherein the initial relation of the brightness control signal and the lighting brightness is written into a non-volatile memory.

3. The calibrating method according to claim 1, wherein the lighting brightness is an average brightness of a plurality of light-emitting diodes of the LED unit.

4. The calibrating method according to claim 1, wherein the initial relation of the brightness control signal and the lighting brightness is presented by a mathematic function or a comparison table.

5. A control method of a light emitting device, wherein the light emitting device comprises at least one light-emitting diode (LED) unit and a memory unit, and the memory unit at least stores an initial relation of a brightness control signal and a lighting brightness for driving the LED unit, the control method comprising steps of:
reading the initial relation from the memory unit; and
determining a value of the brightness control signal for the LED unit according to a brightness requirement and the initial relation.

6. The control method according to claim 5, further comprising a step of:
inputting the brightness control signal to the LED unit.

7. The control method according to claim 5, wherein the LED unit comprises at least one light-emitting diode (LED), at least one first switch element, at least one energy-storage element and at least one photo sense-control element, the first switch element is electrically connected to the LED, the energy-storage element is electrically connected to the first switch element, the photo sense-control element is electrically connected to the energy-storage element, and the control method further comprises steps of:
inputting the brightness control signal to the energy-storage element;
controlling the first switch element according to the brightness control signal so as to enable the LED to emit light; and
enabling the photo sense-control element to sense the illumination energy and to adjust the brightness control signal stored in the energy-storage element.

8. The control method according to claim 7, further comprising a step of:
controlling the first switch element according to the brightness control signal so as to disable the LED.

9. A light emitting device, comprising:
at least one light-emitting diode (LED) unit controlling a lighting brightness thereof according to a brightness control signal;
a memory unit storing an initial relation of the brightness control signal and the lighting brightness of the LED unit; and
a control unit electrically connected to the LED unit and the memory unit, wherein the control unit determines a value of the brightness control signal according to a brightness required signal and the initial relation.

10. The light emitting device according to claim 9, wherein the LED unit comprises:
at least one light-emitting diode (LED);
at least one first switch element electrically connected to the LED;
at least one energy-storage element electrically connected to the first switch element and storing the brightness control signal; and
at least one photo sense-control element electrically connected to the energy-storage element, wherein the photo sense-control element senses an illumination energy of the LED and adjusts the brightness control signal according to the illumination energy, and the first switch element controls the LED according to a value of the brightness control signal.

11. The light emitting device according to claim 10, wherein the energy-storage element comprises a capacitor.

12. The light emitting device according to claim 10, wherein the photo sense-control element comprises at least one photo sensing diode.

13. The light emitting device according to claim 10, further comprising:
a power supplier electrically connected to the LED and providing a power to the LED.

14. The light emitting device according to claim 13, wherein the power is a DC power or an AC power

15. The light emitting device according to claim 13, further comprising:
a rectifier electrically connected to the LED and the power supplier.

16. The light emitting device according to claim 15, wherein the rectifier is a full-bridge rectifier.

17. The light emitting device according to claim 10, wherein the photo sense-control element and the energy-storage element are connected in parallel.

18. The light emitting device according to claim 10, wherein the first switch element and the LED are connected in parallel.

19. The light emitting device according to claim 10, wherein the first switch element and the LED are connected in series.
